(19) United States
(12) Patent Application Publication
(10) Pub. No.: US 2010/0001120 A1
(43) Pub. Date: Jan. 7, 2010

(54) High-speed aircraft with vertical lift and self-revolving ability

(76) Inventor: Wei Hong Sun, Shanghai (CN)

Correspondence Address: BACON & THOMAS, PLLC, 625 SLATERS LANE, FOURTH FLOOR, ALEXANDRIA, VA, 22314-1176, US

(21) Appl. No.: 12/382,504

(22) Filed: Mar. 18, 2009

(30) Foreign Application Priority Data
Jul. 2, 2008 (CN) 200810040110.5

(51) Int. Cl. B64C 27/26; B64C 27/08; B64C 5/04; B64C 25/02; B64C 1/00; B64C 27/52

(52) U.S. Cl. 244/6

(57) ABSTRACT

An aircraft includes a fuselage; a cockpit formed in the fuselage; a coaxial rotor assembly mounted to the top of fuselage, containing an upper rotor and a lower rotor, drivable by a first motor inside the fuselage; wherein, the aircraft also comprises: a couple of fixed wings mounted to the opposite sides of the aircraft respectively; and a rear propeller mounted to the tail end of fuselage, driven by a second motor inside the fuselage. The aircraft of the invention has the advantages of helicopter and autogyro, such as high-safety and high-speed.

### BACKGROUND OF THE INVENTION

1. Field of the Invention

The present invention relates to an aircraft, especially to an aircraft with functions of a helicopter and an autogyro.

2. Description of the Prior Art

A helicopter is almost used in every civil and military field because it can ascend or descend vertically, hover in midair, and travel in any direction such as forward, backward, or sideways. A helicopter is one of rotorcrafts. It is provided with one or more rotors, and each of which is similar to a long propeller. The rotor blade assembly is mounted on a nearly perpendicular rotor shaft over the fuselage and driven by a motor to revolve so as to provide a lifting force, thus the helicopter can ascend or descend vertically. Controlled by a swash plate, the rotor disc can be tilted forward relative to the ground for an angle, such as 6˜15°, so that the direction of the lifting force is changed to provide the helicopter with a horizontal thrust for powering the helicopter to move forward. While the rotor is providing the lift, an undesired torque is simultaneously created to cause the fuselage to revolve in a direction counter to the direction of rotor blade assembly. In order to balance the torque, a configuration of anti-torque is used to diminish the undesired torque. In one of the conventional helicopters, coaxial rotor unit is used, wherein a lower rotor set and an upper rotor set on the same rotor shaft rotates in opposite directions relative to each other so as to balance the torque of fuselage, without the need of a tail rotor. Such a helicopter design associates with a lot of disadvantages such as structural complexity, low-speed, no escaping equipment and no gliding function. When there are some mechanical failures in the rotor blade assembly or the motor assembly, the crewmembers are difficult to escape, so the flight safety measures of such design is insufficient.

Autogyro is developed on the basis of the conventional helicopter. Similar to the conventional helicopter, the autogyro has a long rotor blade assembly mounted above the fuselage, which provides the lifting force during the flight. The difference between the conventional helicopter and the conventional autogyro is that during flight, the rotor blade assembly of the conventional helicopter is voluntarily driven by a motor (actively rotated), and the rotor blade assembly of the conventional autogyro is driven by oncoming airflow (passively rotated). Besides rotor blade assembly difference, the conventional autogyro is furnished with a propeller to provide a horizontal thrust, so the flight speed of autogyro is high. However, the autogyro can not take off and land vertically, and hover in the air like the conventional helicopter. The conventional autogyro has some restrictions to terrain and can not achieve some specific flight task requirements.

### SUMMARY OF THE INVENTION

In view of the limitations in terms of the safety issues of the conventional helicopter and the conventional autogyro, the preferred embodiment provides a new kind of aircraft with the function of vertical maneuvering capability independent to terrain, and gliding ability under mechanical failure.

In order to accomplish the above objectives, the preferred embodiment provides an aircraft comprising:

a fuselage;

a cockpit formed in the fuselage;

a coaxial rotor assembly mounted on the top of the fuselage, containing an upper rotor and a lower rotor, drivable by a first motor inside the fuselage;

wherein, the aircraft also comprises:

a couple of fixed wings mounted on opposite sides of the aircraft respectively; and

a rear propeller mounted on a tail end of the fuselage, driven by a second motor inside the fuselage.

Preferably, the upper rotor and lower rotor have fixed pitch rotor blade.

The aircraft in the preferred embodiment is provided with both the coaxial rotor assembly and the rear propeller, drivable by its own motor respectively. Therefore, when there is a mechanical failure responsible for driving the coaxial rotor assembly, the rear propeller can provide the aircraft with a horizontal thrust to move the aircraft forward continually. In the same time, the rotating rotor is shifted from active rotation into inertial rotation and then into self-rotation, so as to provide the vertical thrust together with the fixed wings mounted on the opposite sides of the fuselage of the aircraft, to proceed with the flight. When there is a breakdown in the motor responsible for the rear propeller, the coaxial rotor assembly can provide both horizontal thrust and vertical thrust to proceed forward in the mode of the conventional helicopter. Since there will be no danger when one motor fails to work, the whole safety of the aircraft is improved.

According to a further objective of the preferred embodiment, an aircraft with the function of helicopter and autogyro is provided.

In order to achieve the above objectives, the coaxial rotor assembly of the preferred embodiment also contains a regulator mounted below the lower rotor and being adjustable by a controller in the cockpit, for adjusting an angle of the rotational surface of rotor relative to the ground. The angle of the rotational surface of rotor relative to the ground is ranged from −45 degree to +45 degree.

Due to the regulator of the coaxial rotor assembly, the angle of the rotational surface of rotor relative to the ground can be adjustable. If necessary, the aircraft can fly in the mode of autogyro. The rear propeller driven by the second motor provides the aircraft with the horizontal thrust, while the coaxial rotor assembly can be tilted backward to form a positive angle of the rotational surface of rotor relative to the ground and self-rotates to provide the aircraft with a vertical thrust during flight. Of course, the aircraft can fly in high-speed mode. In the meantime, the coaxial rotor assembly can also be tilted forward to form a little negative angle of the rotational surface of rotor relative to the ground. Under the effect of airflow, a horizontal component provides a forward power in combination with the power of the rear propeller, so flight of higher-speed is achieved. If the two motors do work, the larger the negative angle of the rotational surface of rotor relative to the ground is, the larger forward thrust the aircraft has, so the aircraft can fly at a very high-speed. Therefore, the aircraft of the preferred embodiment has advantages of both helicopter and autogyro, such as high safety design, high-speed, no limitation of terrain etc.

Preferably, each fixed wing is provided with a flutterable flap for yaw.

In one embodiment of the preferred embodiment, a couple of nose wings are fixed on a front lower end of the fuselage. The nose wings are designed as canard configuration, wherein the path of the airflow passing through the upper side of the nose wing is longer than that of the airflow passing through the lower side of the nose wing, to raise the nose of aircraft with a nose-up moment.

A couple of rear wings are fixed on a tail end of the fuselage, for controlling the flight. Landing gear is fixed under the fuselage, for landing and taking off from the ground.

The aircraft may be made of plastic composite materials such as carbon fiber. All components from the fuselage, rotor to landing gear are made of carbon fiber. Only two motors are made of metal. Therefore, the aircraft is invisible to radar.

### BRIEF DESCRIPTION OF THE DRAWINGS

FIG. 1 is a front view of the aircraft of the preferred embodiment;

FIG. 2 is a top view of the aircraft of the preferred embodiment;

FIG. 3 is an illustrating view of position relation between the first motor and the second motor of the aircraft of the preferred embodiment;

FIG. 4A is an operational front view of a first flight mode of the aircraft of the preferred embodiment;

FIG. 4B is an operational front view of a second flight mode of the aircraft of the preferred embodiment;

FIG. 4C is an operational front view of a third flight mode of the aircraft of the preferred embodiment;

FIG. 5 is a resolution view of the lift when there is an angle of the rotational surface of rotor relative to the ground.

### DETAILED DESCRIPTION OF THE PREFERRED EMBODIMENT

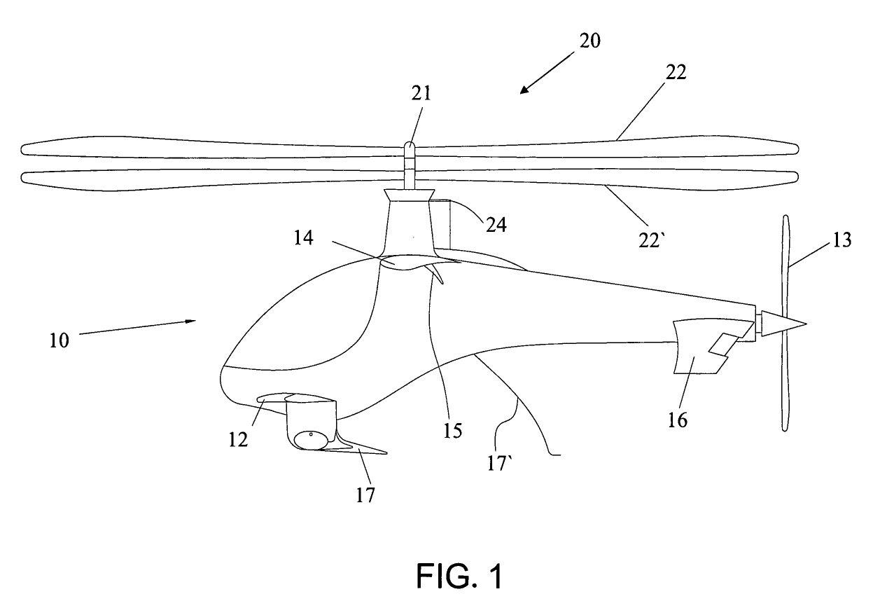

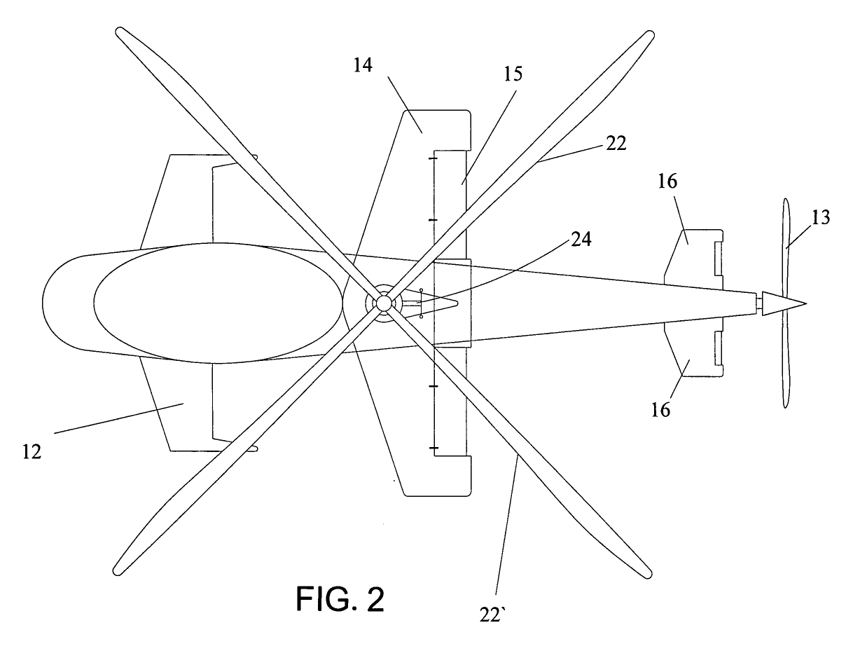

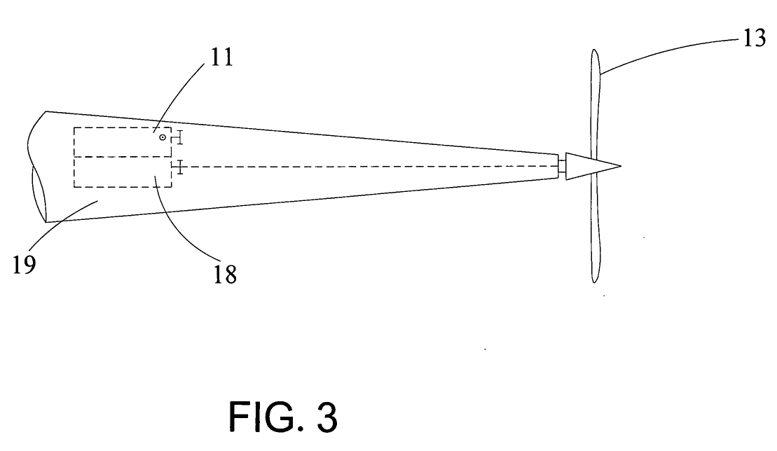

As shown in FIGS. 1 to 3, a front and top view of the aircraft of the preferred embodiment respectively, the aircraft with the functions of vertical lift and self-revolving according to the preferred embodiment comprises:

a fuselage 10, containing a first motor 11 and a second motor 18 therein;

a cockpit 19 formed in the fuselage 10;

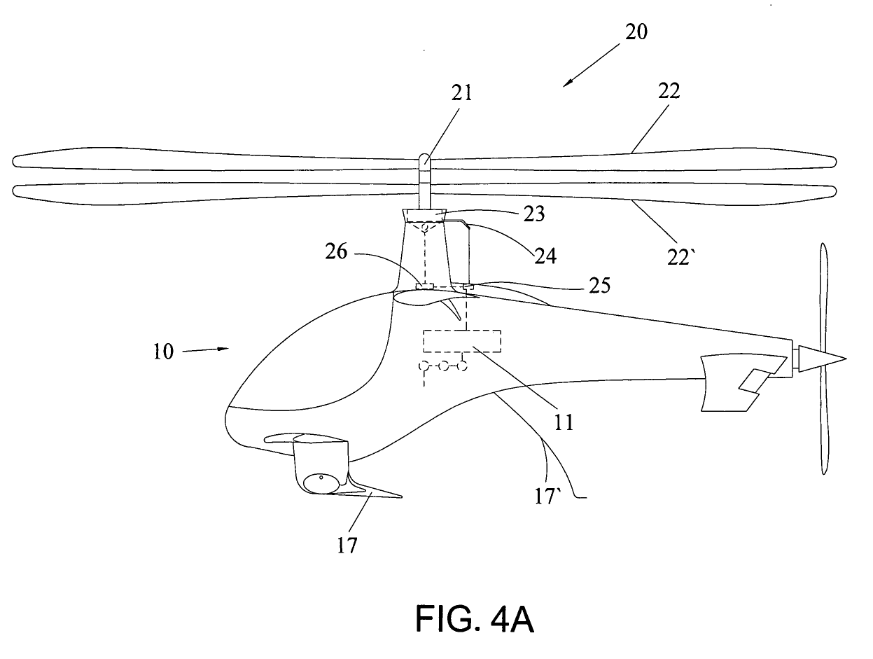

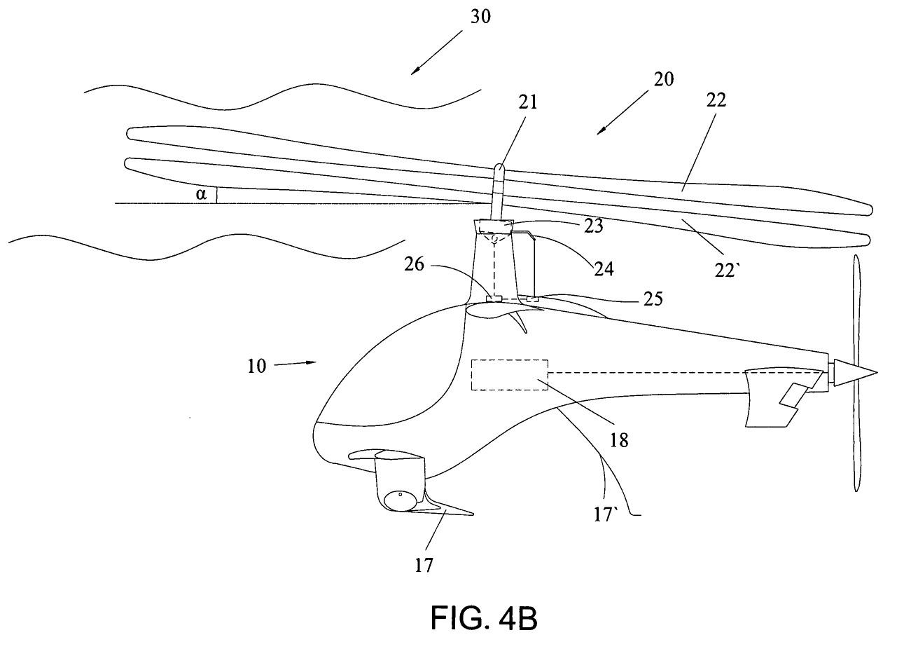

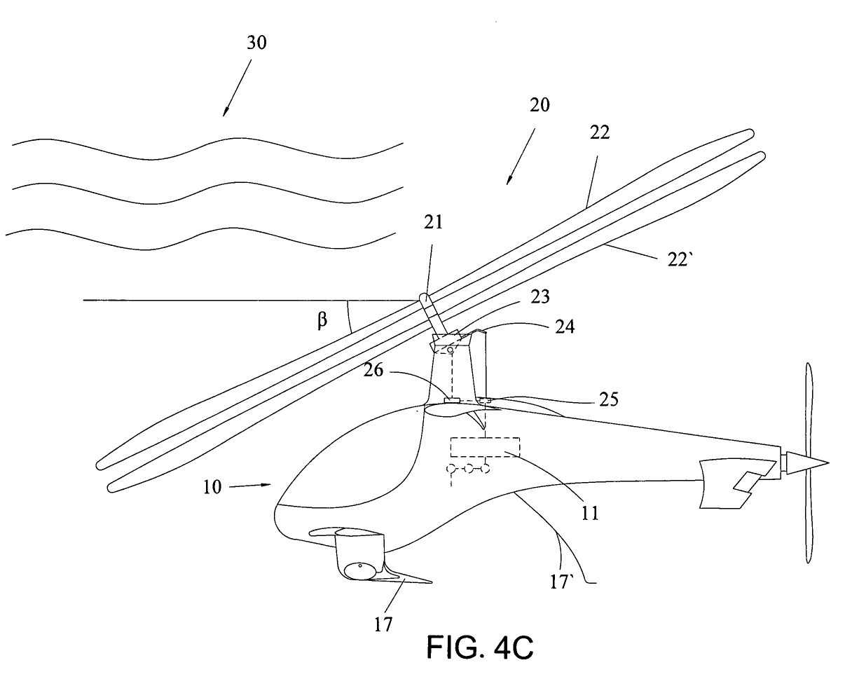

a coaxial rotor assembly 20 mounted on the top of the fuselage 10, wherein the coaxial rotor assembly 20 contains an upper rotor 22 and a lower rotor 22′, installed on a rotor shaft 21 over the fuselage 10 successively. Preferably, the upper rotor 22 and the lower rotor 22′ may have fixed pitch rotor blade. The upper rotor 22 and the lower rotor 22′ may be driven by a first motor 11 inside the fuselage 10. Concretely, as shown in FIG. 4A, the first motor 11 is connected with a belt pulley 25, then to a reduction belt pulley 26 and finally to the rotor shaft 21, to drive the rotor shaft 21. By the rotor shaft 21, the upper rotor 22 and the lower rotor 22′ are rotated in opposite directions relative to each other to balance the undesired torque formed when the lower rotor 22′ and upper rotor 22 rotate, to prevent the fuselage 10 from self-rotation.

A regulator 23 mounted on the rotor shaft 21 below the lower rotor 22′. By use of a regulating handle 24 of the regulator 23, the angle of the rotational surface of rotor relative to the ground is adjustable. The angle of the rotational surface of rotor relative to the ground is ranged from −45 degrees to +45 degrees, preferably from −40 to +20 degree. A considerable horizontal thrust can be provided during the flight under the effect of the oncoming airflow. The concrete means have been disclosed in the prior art.

A couple of fixed wings 14 are mounted on opposite sides of the fuselage 10, and substantially perpendicular to the fuselage 10. Optionally, there is a flutterable flap 15 in each wing 14 for yaw control. The tail end of the fuselage 10 is fixed with a couple of downward rear wings 16 for yaw control also. For example, if the aircraft needs yaw to the left, the flap 15 of the left wing 14 is turned downward, and the flap 15 of the right wing 14 is turned upward, to cause the fuselage 10 to sideward and downward. During the gliding maneuver, the rear wing 16 under the effect of the oncoming airflow produces a force opposite to itself so that the tail end of the aircraft is turned right and the nose of the aircraft is turned left, and vice versa. In a further preferable embodiment, the rear wing 16 may be operated to turn right or left, or the upper rotor 22 and lower rotor 22′ may be operated so as to tilt in different directions to continue the flight.

A rear propeller 13 is mounted on the tail end of fuselage 10 and driven by the second motor 18 inside the fuselage 10, as shown in FIG. 4B, to provide a forward thrust.

Preferably, a couple of nose wings 12 are fixed on a front lower end of the fuselage 10. The nose wings 12 are designed to have a canard configuration, wherein, the path of the airflow passing through the upper side of the nose wing 12 is longer than that of the airflow passing through the lower side of the nose wing 12, to raise the nose of aircraft with a nose-up momentum.

A front landing gear 17 and a back landing gear 17′ are mounted on a bottom of the fuselage 10, for landing the aircraft on the ground.

The aircraft with the rotors having the function of vertical lift and self-revolving according to the preferred embodiment may be made of plastic composite materials such as carbon fiber. All components including fuselage 10, upper rotor 22 and lower rotor 22′, nose wings 12, rear propeller 13, fixed wings 14, flutterable flaps 15, rear wing 16, and landing gears 17, 17′ are made of carbon fiber, except that the two motors 11, 18 are made of metal. Therefore, the aircraft is invisible to radar during flight.

The various kinds of flight modes achievable by the aircraft according to the preferred embodiment are detailed herein in combination with the embodiments.

Flight in the Mode of a Helicopter

As shown in FIG. 4A, when pilot wants the aircraft to take off as a helicopter, he can switch on the first motor 11 to drive the coaxial rotor assembly 20. Concretely, the power is delivered by a belt pulley 25 and a reduction belt pulley 26 successively to the rotor shaft 21. Then the upper rotor 22 and lower rotor 22′ is driven to rotate in clockwise and counterclockwise direction respectively. Due to the opposite rotation of the upper rotor 22 and the lower rotor 22′, the torques so generated by the upper rotor 22 and the lower rotor 22′ can be balanced so as to prevent self-rotation of fuselage 10. Since the upper rotor 22 and the lower rotor 22′ rotate oppositely to balance the torques by the power output by the rotor shaft 21, the upper rotor 22 and the lower rotor 22′ can be long fixed pitch rotor blade, and there is no complex construction such as rear rotor, swash plate and any linkage mechanism.

When the rotation speed of the upper rotor 22 and lower rotor 22′ is high enough to lift the aircraft, the aircraft immediately leave the ground. If pilot wants to land the aircraft on the ground, he can reduce the power of the first motor 11, to decrease the lift. And if the pilot wants the aircraft to fly higher, he can increase the power, to enhance the lift.

Flight in the Mode of an Autogyro

As shown in FIG. 4B, when the pilot wants the aircraft of the preferred embodiment to take off in the mode of autogyro, he can adjust the regulator 23 by use of the regulating handle 24, to adjust the angle of the rotational surface of rotor relative to the ground to be about +3 to +9 degree, and let the second motor 18 do work alone (at this time, the first motor 11 doesn't do work) to drive the rear propeller 13 to provide a forward thrust to the aircraft, to glide forward. At this moment, the upper rotor 22 and lower rotor 22′ of the coaxial rotor assembly 20 pre-rotate under the effect of the oncoming airflow 30. When the pre-rotational rate of the upper rotor 22 and lower rotor 22′ is high enough to take off, the aircraft leaves the ground.

Flight in High-Speed Mode

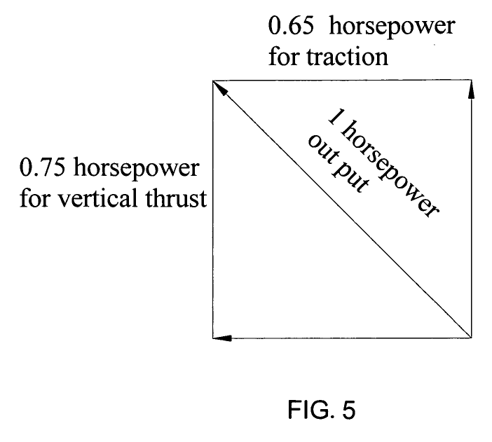

As shown in FIG. 4C, when the pilot wants the aircraft to fly in high-speed mode, he can regulate the angle of the rotational surface of rotor relative to the ground after the aircraft has been in the air and reached a certain height. Especially, the angle of the rotational surface of rotor relative to the ground is much larger than that controlled by swash plate of the conventional helicopter. For example, an angle of the rotational surface of rotor relative to the ground is more than −40 degree. In a preferred embodiment, the angle of the rotational surface of rotor relative to the ground β is −arctan 13/15 degree, as shown in FIG. 5. At the moment, one horsepower output by aircraft can be divided into 0.75 horsepower for vertical thrust and 0.65 horsepower for traction. Therefore, the upper rotor 22 and the lower rotor 22′ can provide the aircraft with a considerable component forward, and the aircraft can achieve the flight in high-speed. Combined with the rear propeller 13 at the tail end of the aircraft driven by the second motor 18, the aircraft of high-speed is further provided with a horizontal thrust, so that the aircraft of the preferred embodiment can achieve the flight at a speed far higher than that of the conventional helicopter. During the high-speed flight, the fixed wings 14 can provide the aircraft with a vertical thrust, to compensate the insufficient vertical thrust provided by the tilting upper rotor 22 and the lower rotor 22′. Due to the large angle of the rotational surface of rotor relative to the ground, the nose of the aircraft will have a nose-down momentum. However, there are nose wings 12 designed as canard configuration at the front lower end of the fuselage 10, so the nose wings 12 can raise the nose of the aircraft with a nose-up momentum, to balance the nose-down momentum.

Flight with High Safety

As shown in FIG. 4C, due to the regulator 23 and the fixed pitch upper rotor 22 and lower rotor 22′, the rotor blades can maintain at the optimum angle of the rotational surface of rotor relative to the ground. If the first motor 11 suddenly breakdown during the flight in high-speed mode, the upper rotor 22 and lower rotor 22′ are shifted from active rotation to inertial rotation. At the moment, the pilot adjust the regulator 23 by use of the regulating handle 24, to tilt the upper rotor 22 and the lower rotor 22′ from forward into backward relative to the ground, i.e. into a state as shown in FIG. 4B. Because the rear propeller 13 is driven by the second motor 18 continuously, the aircraft keeps on flying forward. The upper rotor 22 and lower rotor 22′ are then shifted from inertial rotation to self-rotation under the effect of oncoming airflow, to provide the aircraft with a vertical thrust. The preferred embodiment has achieved that after the motor stops working, the aircraft can shift to the state of self-rotation immediately, i.e. into a mode of autogyro. As a result of this design, crash-free insurance is beyond comparison to all the rotorcrafts in the art. Even if the upper rotor 22 and lower rotor 22′ fail and can not rotate any more, the rear propeller 13 driven by the second motor 18 can still provide the aircraft with a forward thrust, and the fixed wings 14 can provide the aircraft with a vertical thrust, and the flutterable flap 15 on wing 14 can provide the aircraft with yaw control, so that the aircraft constructed in accordance with the preferred embodiment can proceed flight safely.

As shown in FIG. 4C, if the second motor 18 fails suddenly during flight in high-speed mode, the first motor 11 can continue to drive the upper rotor 22 and the lower rotor 22′, so the aircraft can continue to fly safely. In this instance, the large angle of the rotational surface of rotor relative to the ground can be maintained, to provide sufficient forward thrust. Although the speed of flight is not as high as that compared to the situation where the second motor 18 does work simultaneously, the available aerial speed is still higher than that of a conventional helicopter. The pilot in the cockpit 19 can also adjust the regulator 23 by use of the regulating handle 24, to shift the aircraft from high-speed mode into the helicopter mode as shown in FIG. 4A, to fly safely.

In a word, the aircraft of the preferred embodiment is a new kind of rotorcraft compound of coaxial rotor helicopter and coaxial rotor autogyro which has the advantages of both, such as no terrain limitation for takeoff and landing, high-speed, high-safety, simple structure, simple operation and maintain. The aircraft of the preferred embodiment contains two motors. Each one can do work for one mode of flight alone, and also can cooperate to work for a certain flight mode. The aircraft has characteristics of vertical takeoff as a helicopter and high-speed as an autogyro, function and convenience of the conventional helicopter, no complex structure and complicated piloting, and high safety of the conventional autogyro. When the aircraft of the preferred embodiment is used, pilot can select the mode of the conventional helicopter or high-speed helicopter, or the mode of an autogyro. The aircraft of the preferred embodiment is the highest, the most convenient, and the safest micro-aircraft which is invisible to radar and can be used in every field.

What is claimed is:

1. An aircraft comprising:
a fuselage;
a cockpit formed in the fuselage;
a coaxial rotor assembly mounted on top of the fuselage, containing an upper rotor and a lower rotor, installed on a rotor shaft 21 over the fuselage 10 successively, drivable by a first motor inside the fuselage;
a couple of fixed wings mounted on opposite sides of the fuselage respectively; and
a rear propeller mounted on a tail end of the fuselage, driven by a second motor inside the fuselage;
when there is a mechanical failure responsible for driving the coaxial rotor assembly or the rear propeller, the rear propeller or the coaxial rotor assembly can provide the aircraft with a horizontal thrust to move the aircraft forward continually, to improve the safety of flight.

2. The aircraft as claimed in claim 1, wherein the upper and lower rotors have fixed pitch rotor blade.

3. The aircraft as claimed in claim 1, wherein the coaxial rotor assembly also contains a regulator mounted below the lower rotor, adjustable by a controller in the cockpit, for adjusting an angle of the rotational surface of rotor relative to the ground.

4. The aircraft as claimed in claim 3, wherein the angle of the rotational surface of rotor relative to the ground is adjustable by the regulator from −45 to +45 degree.

5. The aircraft as claimed in claim 1, wherein a flutterable flap is mounted on each fixed wing.

6. The aircraft as claimed in claim 1, wherein a couple of nose wings are fixed on a front lower end of the fuselage.

7. The aircraft as claimed in claim 1, wherein a couple of rear wings are fixed on a tail end of the fuselage.

8. The aircraft as claimed in claim 1, wherein a landing gear is fixed under the fuselage.

9. The aircraft as claimed in claim 1, wherein the fuselage, coaxial rotor assembly, fixed wings and rear propeller are made of plastic composite materials.

10. The aircraft as claimed in claim 3, wherein a flutterable flap is mounted on each fixed wing.

11. The aircraft as claimed in claim 3, wherein a couple of nose wings are fixed on a front lower end of the fuselage.

12. The aircraft as claimed in claim 3, wherein a couple of rear wings are fixed on a tail end of the fuselage.

13. The aircraft as claimed in claim 3, wherein a landing gear is fixed under the fuselage.

14. The aircraft as claimed in claim 3, wherein the fuselage, coaxial rotor assembly, fixed wings and rear propeller are made of plastic composite materials.

15. The aircraft as claimed in claim 4, wherein a flutterable flap is mounted on each fixed wing.

16. The aircraft as claimed in claim 4, wherein a couple of nose wings are fixed on a front lower end of the fuselage.

17. The aircraft as claimed in claim 4, wherein a couple of rear wings are fixed on a tail end of the fuselage.

18. The aircraft as claimed in claim 4, wherein a landing gear is fixed under the fuselage.

19. The aircraft as claimed in claim 4, wherein the fuselage, coaxial rotor assembly, fixed wings and rear propeller are made of plastic composite materials.
